(19) United States
(12) Patent Application Publication
(10) Pub. No.: US 2011/0030349 A1
(43) Pub. Date: Feb. 10, 2011

(54) QUICK-HEATING OF A UREA SUPPLY CONDUIT FOR AN ENGINE EXHAUST AFTER-TREATMENT SYSTEM

(75) Inventors: Andrei Makartchouk, Hinsdale, IL (US); Adam C. Lack, Willow Springs, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/535,023

(22) Filed: Aug. 4, 2009

(51) Int. Cl. F02D 45/00; F01P 5/10; F01N 3/10

(52) U.S. Cl. 60/286; 123/41.44; 60/303; 60/299

(57) ABSTRACT

A urea supply conduit (68) has a wall of good thermal conductivity. Urea solution in liquid phase is sucked out of a tank (24) through conduit (68) and delivered to a point of use (22) in an engine exhaust after-treatment system (18) through which products of combustion are conveyed from engine combustion chambers (16) to atmosphere. Liquid engine coolant is circulated through a coolant conduit (66) that has a wall of good thermal conductivity placed side-by-side and in physical association with the urea supply conduit wall to form a thermal conduction path for heat transfer between coolant in the coolant conduit and urea in the urea supply conduit, more quickly thawing any frozen urea.

### FIELD OF THE INVENTION

This invention relates to internal combustion engines, especially motor vehicle engines that utilize urea dosing for after-treatment of engine exhaust.

### BACKGROUND OF THE INVENTION

The performance of a diesel engine after-treatment system in converting NOₓ to other chemical products by selective catalytic reduction (SCR) relies on the presence of ammonia in the exhaust stream. Dosing engine exhaust by injection of aqueous urea, an ammonia-based reductant, into the exhaust stream at a location upstream of an SCR catalyst is one way to introduce ammonia into the exhaust system.

For promptly commencing the conversion of NOₓ in engine exhaust gas to other chemical products through catalytic action upon engine starting, a urea dosing system needs to become effective in as short a time as possible. A known design practice places a urea injector at a location in the engine exhaust system where it can spray urea solution into the exhaust stream ahead of the SCR catalyst with the objective of completely evaporating the solution by the time it reaches the catalyst. Incomplete evaporation can lead to undesired consequences such as the formation of solid deposits in the exhaust system and poor performance of the after-treatment system.

When a “cold” engine is started in warm ambient temperatures, aqueous urea stored in an on-board urea tank is in the liquid phase and therefore sufficiently fluid for pumping to the urea injector.

Because the urea injector pierces the exhaust system, it begins to absorb heat from the passing exhaust gases essentially as soon as the engine starts. That is typically not objectionable, at least until such time as it becomes necessary to limit injector temperature due to exposure to significantly elevated exhaust gas temperatures. Those extremely high temperatures can occur when a diesel particulate filter (DPF) located upstream of an injector is being regenerated. In order to limit injector temperature rise it is known to circulate liquid coolant from the engine cooling system through internal coolant passages in the injector. Depending on relative temperatures of engine exhaust gas and engine coolant, the circulation of engine coolant may be controlled in any suitably appropriate way such as by a control valve, or it may be left uncontrolled and therefore essentially continuous.

The use of engine coolant for thermal management of a urea injector may also extend to thermal management of the urea tank and a supply pump that pumps solution from the tank to the injector. Thermal management of the pump and the tank is important because in a motor vehicle such as a truck, the latter two components are typically mounted on the motor vehicle chassis where the urea solution is continually exposed to ambient temperature. In cold ambient temperatures near and below about 12° F., the solution in the tank, the pump, and associated conduits can freeze while in torrid ambient temperatures, the solution can become slush, significantly reducing its effectiveness when injected into the after-treatment system.

Certain governmental regulations applicable to certain motor vehicles require that when a “cold” engine is started in ambient temperatures sufficiently cold that urea solution in the tank and/or associated conduits and components is completely and/or partially frozen, the after-treatment system must become effective within certain time constraints. Hence thawing of frozen urea that might otherwise adversely impact regulatory compliance is essential.

It has been proposed to immerse a heating element in the urea tank and to flow engine coolant through it in order to hasten thawing of frozen solution so that liquid solution can be sucked out of the tank by the supply pump and conveyed to the injector for spraying into the exhaust. Such a tank comprises several ports including a coolant inlet port, a coolant outlet port, a urea suction port, a urea backflow port, and a vent port.

The immersed heating element is disposed in heat exchange relationship with the contents of the tank to form a segment of a coolant flow path that runs through the urea dosing system, the in-tank segment running between the tank's coolant inlet port and the tank's coolant outlet port. Engine coolant from the engine cooling system enters the tank via the tank's coolant inlet port and leaves via the tank's coolant outlet port. After leaving the tank, the coolant flow path that runs through the dosing system may pass through a coolant passageway in the supply pump before returning to the engine.

The urea suction port of the tank, which is typically at or near the top of the tank, is placed in fluid communication with a suction inlet of the supply pump via a supply conduit. A pick-up tube extends downward within the tank from the suction port to terminate in an entrance near the bottom of the tank. When the supply pump operates, the venting of the tank allows the pump to draw solution from the bottom of the tank into and through the pick-up tube, and then through the supply conduit. A urea outlet port of the pump is placed in fluid communication with the urea injector via an injector supply conduit to provide for the solution drawn from the tank through the supply pump to be conveyed to the injector. A backflow conduit extends from the pump to the backflow port of the tank to return excess solution to the tank.

The inventors have observed a failure of one proposed urea dosing system to comply with applicable criteria for thawing frozen urea and have discovered a cause for that deficiency. The result of their discovery has led them to devise a construction for accelerating thawing by a more efficient transfer of heat from engine coolant to urea solution in the dosing system.

### SUMMARY OF THE INVENTION

Consequently, the present invention relates generally to an improvement for thermal management of a dosing system that delivers a dosing fluid, or agent, to an engine exhaust after-treatment system, especially an improvement for quick-heating certain dosing system components in a motor vehicle where those components and/or conduits associated with them are exposed to ambient temperatures that at times are sufficiently low to freeze dosing fluid in the dosing system.

The invention is effective to more efficiently transfer engine coolant heat to dosing fluid, thereby accelerating the thawing of frozen solution in sub-freezing ambient temperatures, an important factor for achieving compliance of an after-treatment system with relevant governmental regulations.

The disclosed embodiment of the invention is a urea dosing system that introduces aqueous urea into the after-treatment system upstream of an SCR catalyst that serves to promote chemical reaction of the injected reductant with NOₓ in engine exhaust gas to convert the latter to other chemical products before the exhaust enters the atmosphere.

The invention, as particularly applied to respective conduits through which coolant enters and urea solution leaves a urea tank, addresses certain situations that may occur after the engine has been shut down in cold ambient conditions, a specific example being the accumulation and eventual freezing of droplets of urea solution and water condensation in the conduit that serves as a urea pick-up tube.

A general aspect of the invention relates to an internal combustion engine comprising combustion chambers within which fuel is combusted to operate the engine, a cooling system, including a coolant pump, for circulating liquid engine coolant through the engine, an exhaust after-treatment system through which products of combustion are conveyed from the combustion chambers to atmosphere, and a dosing system for introducing dosing fluid into the exhaust after-treatment system for use in an exhaust gas after-treatment process carried out in the after-treatment system.

The dosing system comprises a dosing fluid conduit having a thermally conductive wall for conveying dosing fluid toward a point of introduction into the after-treatment system and a coolant circuit through which liquid engine coolant circulates in heat exchange relationship with at least a portion of the dosing system. A portion of the coolant circuit comprises a coolant conduit through which engine coolant is conveyed and which has a thermally conductive wall disposed side-by-side and physically associated with the thermally conductive wall of the dosing conduit to form a thermal conduction path for conductive heat transfer from relatively hotter coolant in the coolant conduit to relatively cooler dosing fluid in the dosing conduit.

Another general aspect of the invention relates to a method of heating urea solution in solid or liquid phase in a urea supply conduit which has a thermally conductive wall and through which urea solution in liquid phase is delivered from a tank to a point of use in an engine exhaust after-treatment system through which products of combustion are conveyed from engine combustion chambers to atmosphere.

The method comprises circulating liquid engine coolant through a coolant conduit that has a thermally conductive wall placed side-by-side and in physical association with the thermally conductive wall of the urea supply conduit to form a thermal conduction path for heat transfer between coolant in the coolant conduit and urea in the urea supply conduit.

The foregoing, along with further features and advantages of the invention, will be seen in the following disclosure of a presently preferred embodiment of the invention depicting the best mode contemplated at this time for carrying out the invention. This specification includes a drawing, now briefly described as follows.

### BRIEF DESCRIPTION OF THE DRAWINGS

FIG. 1 is a general schematic diagram of a diesel engine including a cooling system portion, an exhaust after-treatment portion, and after-treatment dosing components, in accordance with principles of the present invention.

FIG. 2 is an enlarged view of a portion of one of the dosing components that has been removed from that component for purposes of illustration.

FIG. 3 is a transverse cross section view in the direction of arrows 3-3 in FIG. 2.

FIG. 4 is a view similar to FIG. 3 showing a modified form.

FIG. 5 is a view similar to FIG. 3 showing another modified form.

FIG. 6 is a view similar to FIG. 3 showing still another modified form.

### DESCRIPTION OF THE PREFERRED EMBODIMENT

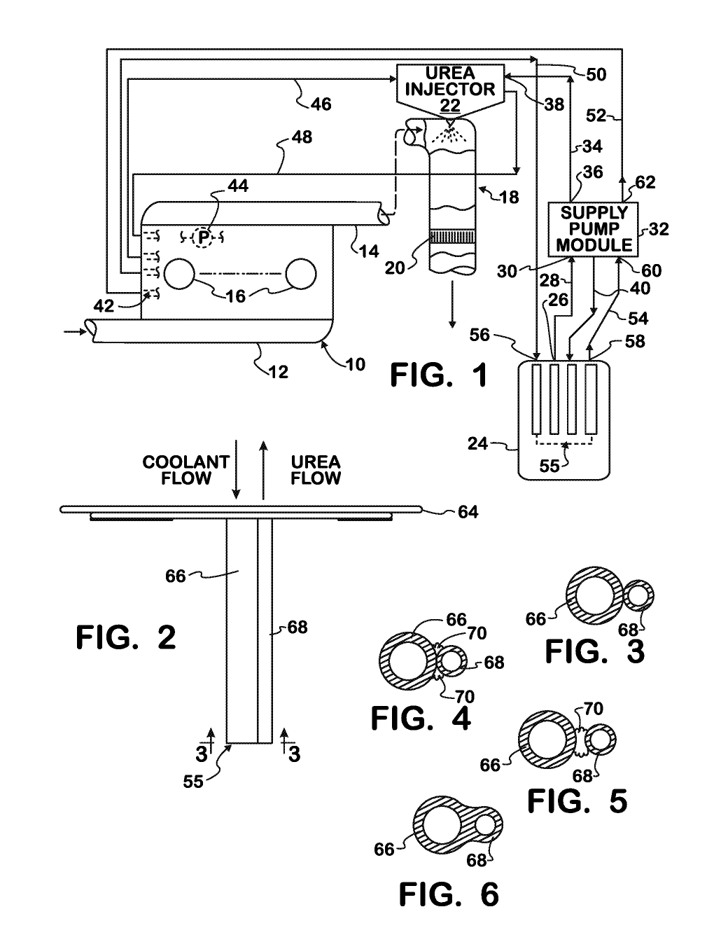

FIG. 1 shows a diesel engine 10 comprising an intake system 12 through which charge air enters and an exhaust system 14 through which exhaust gas resulting combustion exits, not all details of those two systems that are typically present being shown. Engine 10 comprises a number of cylinders 16 forming combustion chambers into which fuel is injected by fuel injectors to combust with the charge air that has entered through intake system 12. Energy released by combustion powers the engine via pistons connected to a crankshaft. When used to propel a motor vehicle, such as a truck, engine 10 is coupled through a drivetrain to driven wheels that propel the vehicle. Intake valves control the admission of charge air into cylinders 16, and exhaust valves control the outflow of exhaust gas through exhaust system 14 and ultimately to atmosphere. Before entering the atmosphere however, the exhaust gas is treated by one or more after-treatment devices in an after-treatment system 18.

One such after-treatment device is an SCR catalyst 20. A urea injector 22 is mounted on a portion of exhaust system 14 upstream of catalyst 20 with its outlet, or nozzle, arranged to spray aqueous urea into the exhaust system for entrainment with, and evaporatively mixing throughout, engine exhaust gas coming from cylinders 16. Catalyst 20 promotes a chemical reaction between the reductant and NOₓ in the exhaust gas that converts substantial amounts of NOₓ to other products before the exhaust gas passes into the atmosphere.

A tank 24 holds a supply of aqueous urea and is suitably vented through a vent port (not shown) to allow solution to be sucked out via a urea outlet port 26. A conduit 28 extends from port 26 to an inlet port 30 of a supply pump module 32. A conduit 34 extends from an outlet port 36 of supply pump module 32 to an inlet 38 of injector 22.

When supply pump module 32 operates, it draws solution from tank 24 through conduit 28 and pumps the solution through conduit 34 to injector 22, with a backflow conduit 40 returning excess solution to tank 24.

Engine 10 further comprises a liquid cooling system 42 through which engine coolant is circulated by a pump 44. Two conduits 46, 48 provide for pump 44 to circulate engine coolant through a coolant passageway in injector 22. Three more conduits 50, 52, 54 provide for pump 44 to circulate engine coolant through the coolant passageway of a heating element 55 that runs through the interior of tank 24 in heat exchange relationship with solution in the tank and then through a coolant passageway in pump module 32.

Conduit 50 connects to a coolant inlet port 56 of tank 24. Conduit 54 connects a coolant outlet port 58 of tank 24 to a coolant inlet port 60 of pump module 32. Conduit 52 returns coolant from a coolant outlet port 62 of pump module 32 to engine cooling system 42.

The suction side of pump 44 acts through conduits 48 and 52 to apply suction to a coolant outlet port of injector 22 and to port 62.

The suction applied to the coolant outlet port of injector 22 is effective to draw coolant from the engine through conduit 46, a coolant passage or passages in the body of injector 22, and back to the engine via conduit 48. The suction applied to coolant outlet port 62 is effective to draw coolant from the engine through conduit 50, through the coolant passageway in tank 24 that includes heating element 55, through conduit 54, through the coolant passageway in pump module 32, and then back to the engine via conduit 52.

FIGS. 2 and 3 show a top wall 64 of tank 24, a segment 66 of heating element 55 extending vertically downward from wall 64, and a segment of a urea pick-up tube 68 also extending downward from top wall 64. The drawing doesn't show the couplings that have connection points on either side of the top wall to provide for each external conduit to have fluid communication through the respective coupling with the respective internal conduit, for example to communicate conduit 50 and conduit 66, so that fluid can pass through the top wall.

Heating element 55 is essentially a tube having a geometry appropriate for the geometry of the tank interior. For example, segment 66 may extend downward almost to the bottom wall of the tank where it merges with a generally horizontal bottom segment that runs laterally either straight or curved to a vertical exit segment that extends upward to back wall 64 although the bottom and exit segments are not shown in FIG. 2.

In accordance with principles of the invention, heat is transferred more efficiently from relatively warmer engine coolant entering tank 24 at inlet port 56 to relatively cooler urea solution (either frozen or liquid) in pick-up tube 68 by fabricating them from material of good thermal conductivity and by physically associating their thermally conductive walls side-by-side so as to form a thermal conduction path for heat transfer between coolant in segment 66 and urea in pick-up tube 68. FIG. 2 shows the respective flows to be in counter-flow relationship.

Creation of the thermal conduction path can be accomplished in different ways, several of which are shown in FIGS. 3-6.

FIG. 3 shows the two having being joined in mutual abutment by a process that heated their materials just enough to allow them to slightly melt and unite upon removal of the heat.

FIG. 4 shows the two having being joined in mutual abutment by welding, with weldment 70 filling the roots of the opposed crevices created by the mutual abutment.

FIG. 5 shows the two having being joined also by welding, but with some weldment 70 that separates them from surface-to-surface contact being disposed in the thermally conductive path.

FIG. 6 shows the two integrally joined during their manufacture by a co-extrusion process.

It should be noticed in all of these examples that heat transfer is performed entirely by conduction through solid material, a method that transfers heat significantly more rapidly than alternative methods. Hence, quick heating of urea solution in either solid (frozen) or liquid phase occurs.

While a presently preferred embodiment of the invention has been illustrated and described, it should be appreciated that principles of the invention apply to all embodiments falling within the scope of the following claims.

What is claimed is:

1. An internal combustion engine comprising:
combustion chambers within which fuel is combusted to operate the engine;
a cooling system, including a coolant pump, for circulating liquid engine coolant through the engine;
an exhaust after-treatment system through which products of combustion are conveyed from the combustion chambers to atmosphere;
and a dosing system for introducing dosing fluid into the exhaust after-treatment system for use in an exhaust gas after-treatment process carried out in the after-treatment system,
wherein the dosing system comprises a dosing fluid conduit having a thermally conductive wall for conveying dosing fluid toward a point of introduction into the after-treatment system and a coolant circuit through which liquid engine coolant circulates in heat exchange relationship with at least a portion of the dosing system, a portion of the coolant circuit comprising a coolant conduit through which engine coolant is conveyed and which has a thermally conductive wall disposed side-by-side and physically associated with the thermally conductive wall of the dosing fluid conduit to form a thermal conduction path for heat transfer between coolant in the coolant conduit and dosing fluid in the dosing fluid conduit.

2. An engine as set forth in claim 1 wherein the respective conduits comprise separate tubes, and the side-by-side walls are physically associated by being in mutual abutment along portions of their respective lengths.

3. An engine as set forth in claim 2 including material that engages both tubes and is effective to cause the side-by-side walls to be maintained in mutual abutment along portions of their respective lengths.

4. An engine as set forth in claim 2 including a thermally conductive medium that is disposed in a portion of the thermal conduction path and that is effective to cause the side-by-side walls to be maintained in mutual abutment along portions of their respective lengths.

5. An engine as set forth in claim 1 wherein the respective conduits are arranged such that the respective flows along the side-by-side walls are in counter-flow relationship.

6. An engine as set forth in claim 1 wherein the dosing system comprises a tank for holding a supply of dosing fluid, and the thermal conduction path is disposed within the interior of the tank.

7. An engine as set forth in claim 6 wherein the tank comprises a top end wall, and the side-by-side walls are disposed in vertical portions of the respective conduits with the thermal conduction path running vertically downward within the interior of the tank from substantially the inside of the top wall of the tank.

8. An engine as set forth in claim 7 wherein the dosing system comprises a supply pump for pumping dosing fluid from the tank into the exhaust system through an injector, and the dosing conduit is in fluid communication with a suction port of the supply pump.

9. An engine as set forth in claim 1 wherein the after-treatment system comprises an SCR catalyst that serves to promote chemical reaction of reductant that the dosing system introduces into engine exhaust gas and NOₓ in engine exhaust gas to other chemical products before the exhaust enters the atmosphere.

10. A method of heating urea solution in solid or liquid phase in a urea supply conduit which has a thermally conductive wall and through which urea solution in liquid phase is delivered from a tank to a point of use in an engine exhaust after-treatment system through which products of combustion are conveyed from engine combustion chambers to atmosphere, the method comprising:
circulating liquid engine coolant through a coolant conduit that has a wall of thermally conductive wall placed side-by-side and in physical association with the thermally conductive wall of the urea supply conduit to form a thermal conduction path for heat transfer between coolant in the coolant conduit and urea in the urea supply conduit.
